(19) United States
(12) Patent Application Publication
(10) Pub. No.: US 2009/0133377 A1
(43) Pub. Date: May 28, 2009

(54) MULTI-TUBE PULSE DETONATION COMBUSTOR BASED ENGINE

(75) Inventors: Ross Hartley Kenyon, Waterford, NY (US); Narendra Digamber Joshi, Shenectady, NY (US); Venkat Eswarlu Tangirala, Niskayuna, NY (US); Anthony John Dean, Scotia, NY (US); Adam Rasheed, Glenville, NY (US); Aaron Jerome Glaser, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Shenectady, NY (US)

(21) Appl. No.: 12/270,980

(22) Filed: Nov. 14, 2008

Related U.S. Application Data
(60) Provisional application No. 60/988,171, filed on Nov. 15, 2007.

(51) Int. Cl. F02C 5/02

(52) U.S. Cl. 60/39.76

(57) ABSTRACT

An engine contains a compressor stage, a pulse detonation combustion stage and a turbine stage. The pulse detonation combustion stage contains at least one pulse detonation combustor which has an inlet portion. The pulse detonation combustor is positioned such that the inlet portion of the pulse detonation combustor is located forward of an outlet of the compressor stage with respect to the engine. The pulse detonation combustor is angled with respect to a centerline of the engine.

### PRIORITY

This invention claims priority to U.S. Provisional Application 60/988,171 filed on Nov. 15, 2007, the entire disclosure of which is incorporated herein by reference.

### BACKGROUND OF THE INVENTION

This invention relates to pulse detonation systems, and more particularly, to a multi-tube pulse detonation combustor based engine.

With the recent development of pulse detonation combustors (PDCs) and engines (PDEs), various efforts have been underway to use PDC/Es in practical applications, such as in aircraft engines and/or as means to generate additional thrust/propulsion. Further, there are efforts to employ PDC/E devices into “hybrid” type engines which use a combination of both conventional gas turbine engine technology and PDC/E technology in an effort to maximize operational efficiency. It is for either of these applications that the following discussion will be directed. It is noted that the following discussion will be directed to “pulse detonation combustors” (i.e. PDCs). However, the use of this term is intended to include pulse detonation engines, and the like.

Because of the recent development of PDCs and an increased interest in finding practical applications and uses for these devices, there is an increasing interest in increasing their operational and performance efficiencies, as well as incorporating PDCs in such a way so as to make their use practical.

In some applications, attempts have been made to replace standard combustion stages of engines with a single PDC. However, because of the forces and stresses involved, relatively large PDCs can be impractical. This is due to the need for very thick wall structures, along with other components, and the need for relatively long blow down PDC tubes to initiate a detonation. The larger the diameter of the PDC the larger the blow down tube needs to be. In many engine applications, this added length is problematic.

Additionally, it is known that the operation of PDCs creates extremely high pressure peaks and oscillations both within the PDC and upstream components, as well as generating high heat within the PDC tubes and surrounding components. Because of these high temperatures and pressure peaks and oscillations during PDC operation, it is difficult to develop operational systems which can sustain long term exposure to these repeated high temperature and pressure peaks/oscillations.

Further, because of the need to block the pressure peaks from upstream components, various valving techniques are being developed to prevent high pressure peaks from traveling upstream to the compressor. However, this repeated blocking and unblocking by the valve itself can create unsteady flow oscillations that cause less than optimal compressor operation.

Therefore, there exists a need for an improved method of implementing PDCs in turbine based engines and power generation devices, which address the drawbacks discussed above.

### SUMMARY OF THE INVENTION

In an embodiment of the present invention, an engine contains a compressor stage having an outlet through which a compressed flow passes, a pulse detonation combustor stage comprising at least one pulse detonation combustor, where the pulse detonation combustor stage is coupled to the compressor stage, and a turbine stage coupled to the pulse detonation combustor stage which receives an exhaust from the pulse detonation combustor stage. The at least one pulse detonation combustor comprises an inlet portion which is positioned such that at least some of the compressed flow from the compressor stage travels to the inlet portion in a direction substantially opposite that of a flow of the pulse detonation combustor.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

As used herein, engine means any device used to generate thrust and/or power.

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 shows a diagrammatical representation of an exemplary embodiment of the present invention;

FIG. 2A shows a diagrammatical representation of a can-annular arrangement in accordance with an exemplary embodiment of the present invention;

FIG. 2B shows a diagrammatical representation of a PDC tube manifold structure in accordance with an embodiment of the present invention;

FIG. 3 shows a diagrammatical representation of an alternative exemplary embodiment of the present invention; and

FIG. 4 shows diagrammatical representations of two alternative PDC orientations in accordance with exemplary embodiments of the present invention.

### DETAILED DESCRIPTION OF THE INVENTION

The present invention will be explained in further detail by making reference to the accompanying drawings, which do not limit the scope of the invention in any way.

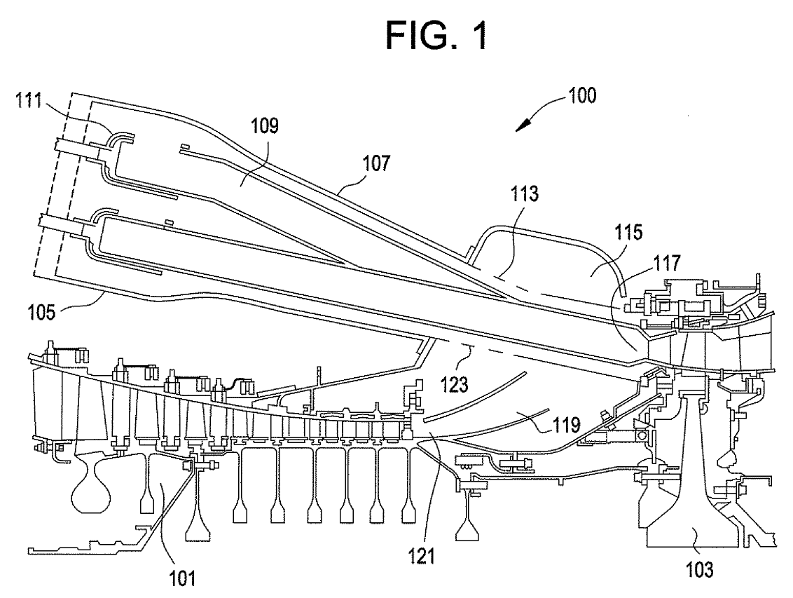

FIG. 1 depicts a portion of an engine 100 in accordance with an embodiment of the present invention. As shown, the engine 100 contains a compressor stage 101 and a turbine stage 103. These stages are configured in any known or conventional way. Positioned downstream of the compressor stage 101 and upstream of the turbine stage 103 is a PDC stage 105. In the exemplary embodiment shown, the PDC stage 105 fully replaces a conventional combustor stage, such that the PDC stage 105 fully provides the energy normally supplied by the combustion stage. However, the present invention is not limited in this regard. Specifically, it is also contemplated that the PDC stage 105 of the present invention is employed with a combustion stage within the engine 105. This would be similar to a hybrid PDC engine type in which a normal combustion stage is coupled with PDCs to provide additional energy to the system.

Within the PDC stage 105 are a plurality of PDCs 109 which are located within the PDC stage casing 107. As can be seen, the PDCs 109 are annularly positioned within respect to the engine 100. By positioning the PDC stage 105 and its components, as shown, the overall length of the engine 100 is reduced, making the length more commensurate in scope with traditional engine lengths. In traditional implementations the PDCs are positioned fully between the compressor stage 101 and the turbine stage 103, thus greatly increasing the overall length of the engine 100.

Each of the PDCs 109 has a known configuration. The present invention is not limited in this regard. It is contemplated that any known or conventional type of PDC can be employed in the present invention.

In another exemplary embodiment, the PDC stage 105 can contain a mixture of PDCs 109 and deflagration-based combusted devices. Accordingly, embodiments of the present invention are not intended to be limited to applications in which the entire combustion operation is provided by PDCs.

In an exemplary embodiment of the present invention, each of the PDCs 109 contains a PDC inlet valve structure 111. The inlet valve structure 111 allows for the entry of air and/or an air/fuel mixture, where at least some of the air is provided from the compressor stage 101. As shown in FIG. 1, the inlet valving 111 of the PDCs 109 is located radially with respect to the centerline of the engine 100. In the shown embodiment, during operation the compressed flow exits the outlet 121 of the compressor stage 101 and is then directed forward (i.e., the flow is turned) to the inlet valving 111 of the PDCs 109. The present invention is not limited to this embodiment. In another exemplary embodiment, the inlet valving 111 is positioned both radially and forward for the outlet 121 (as shown in FIG. 1).

It is noted that any known inlet valving 111 structure or configuration can be employed. There is no limitation in this regard. However, in an exemplary embodiment, the valving 111 is configured to minimize or prevent pressure peaks from with the PDCs 109 (created during operation) from exiting the valving 111 and entering the cavity of the casing 107. Further, the timing and operation of the valving is not limiting. In one embodiment, all of the PDCs 109 are operated simultaneously such that their operations are in-sync. In a further exemplary embodiment, the operation of the PDCs is sequenced such that not all PDCs are firing at the same time, but their operation is staggered. Further, the present invention is not intended to be limited by the fuel injection system employed. Known valving controls methods, structure and techniques can be employed in the various embodiments of the present invention. The present invention is not intended to be limited by the valving methodologies employed.

By positioning the inlet valving 111 of the PDCs 109 forward of the compressor outlet 121, the exemplary embodiments of the present invention aid in minimizing the unsteady compressor exit flows experienced in traditional PDC implementations. In the shown embodiment, by positioning the inlet valving 111 forward of the compressor outlet 121, any pressure fluctuations which are generated by the PDC 109 operation are diffused within the casing 107 prior to reaching the compressor outlet 121. Thus, the compressor stage 101 “sees” a relatively steady flow, and its operation can be optimized.

Additionally, this configuration allows for optimal packaging of the PDCs 109 within the engine 100 environment. That is, the overall length of the engine 100 can be reduced by this configuration. Further, the physical distance and volume between the PDC inlet valving 111 and the compressor outlet 121 aids in dampening the flow unsteadiness.

Further, by directing the compressor flow forward within the casing 107, cooling of the PDCs 109 is enabled. As described earlier, PDC operation generates a considerable amount of heat, such that the walls of a PDC can reach very high temperatures. Various methods have been contemplated for cooling these walls. Many methods require the use of additional cooling structure and/or systems which add cost, weight and complexity to the engine.

In exemplary embodiments of the present invention, the compressor flow is directed within the casing 107 toward the inlet 111 and thus along the exterior surfaces of the PDCs 109. Because the flow from the compressor stage 101 is typically relatively cool, this flow acts as a heat exchanger as it flows along the PDC 109 walls up to the inlet valving 111. Moreover, as the flow takes heat from the PDC 109 walls, the flow temperature increases. This aids in the operation of the PDC as an increased air flow temperature can assist in the detonation procedure.

Thus, embodiments of the present invention employ a configuration which allows the casing 107 and PDCs 109 to act as a reverse flow heat exchanger. That is, the compressor flow is directed into the casing 107 surrounding the PDCs 109 and flows in a direction towards the inlet valving 111 which is substantially opposite the direction of the flow of the PDC 109. It is known that during PDC operation some of the hottest regions of the PDC are the nozzle 117 and the area in which the detonation occurs. By employing the shroud 123 and/or the casing 107 compressor flow is directed to these areas to provide cooling. Additionally, because of the orientation of the PDC 109 and the positioning of the inlet valving 111 a reverse flow heat exchanger is provided by having the compressor flow traveling in a direction into the inlet valving 111 which is substantially opposite the exhaust flow of the PDC 109. This allows the compressor flow to providing cooling of the outer surface of the PDCs 109. In an exemplary embodiment of the present invention, the compressor flow travels in a direction within the casing which is substantially 180 degrees opposite that of a direction of flow within the PDC 109.

In a further exemplary embodiment of the present invention, turbulators or other surface protrusions are placed on the outer surface of the PDC tubes 109. Turbulators, and the like, aid the heat exchanging process by providing further surface area for heat exchanging. Additional surface texturing, such as dimpling etc., can be employed. Further, the turbulators can have a shape which aid in controlling the compressor flow within the casing 107 as it flows to the inlet valving.

In another exemplary embodiment of the invention, to increase the heat exchange aspects of the walls of the PDCs 109, the walls are configured with turbulators, vanes or baffles, or the like. This will increase the heat exchange between the PDCs 109 and the flow. Further, these structures (not shown) can be used to direct and otherwise control the flow through the casing 107 to the inlet valving 111.

As shown in FIG. 1, in the depicted embodiment the PDCs 109 are angled with respect to the centerline of the engine 100. By angling the PDCs 109 with respect to the centerline of the engine 100 it is relatively easy to redirect the flow from the outlet 121 to the inlet valving 111. In an embodiment of the present invention, the PDCs 109 are positioned such that they are angled with respect to the centerline of the engine. The angling of the PDCs 109, or portions of the PDCs 109 can be meridionally or tangentially. In an exemplary embodiment, the angle to the engine centerline is minimized to reduce the heat load on downstream components and the PDC tube sidewall at any angled points. However, in another embodiment of the present invention, the PDCs 109 are positioned such that they are parallel to the centerline of the engine 100. In this configuration, the casing 107, nozzle 117 and any nozzle manifold structure (not shown) are to be configured such that flow transition of compressor flow to the inlet valving 111 and PDC exhaust flow to the turbine stage 103 is optimized. Such a configuration can be used when radial space for the engine 100 is limited.

As shown in FIG. 1, an exemplary embodiment of the present invention contains a diffuser 119 which directs flow from the outlet 121 into the PDC stage 105. The diffuser 119 aids in turning the flow from the outlet 121 into the PDC stage 105 such that the flow transition and redirection is optimized. In an embodiment of the invention, the flow is redirected such that turbulence is minimized.

In a further exemplary embodiment, the PDC stage 105 contains a plenum 115. The plenum 115 is employed to aid in the pressure rise mitigation. Specifically, the plenum 115 provides additional cavity space to aid in the dissipation and/or absorption of pressure fluctuations that are experienced due to the operation of the PDCs 109. As is known, air is a relatively compressible medium, and thus by increasing the overall volume of the PDC stage 105, by adding a plenum 115, the volume of air used to dissipate any pressure fluctuations is increased. It is noted that the plenum configuration and location shown in FIG. 1 is intended to be exemplary and the present invention is not limited to the embodiment shown.

Further, in an alternative exemplary embodiment (as shown in FIG. 1) surrounding the PDCs 109 is a tube shroud 113. The shroud 113 aids in directing flow from the compressor stage 101 to the walls of the PDCs 109 as well as controlling the flow within the area of the plenum 115. Further, the shroud 113 may contain flow control openings 123 which assist in flow direction as well as pressure peak mitigation and/or dissipation. The configuration of the plenum 115, casing 107 diffuser 119 and/or shroud 113 can be optimized, by those of ordinary skill in the art, such that the desired operational and performance characteristics are achieved. Specifically, those of ordinary skill the art are sufficiently capable of optimizing these components to achieve the desired cooling and pressure peak minimization/dissipation to ensure the desired operation of the PDC 109 and the compressor stage 101.

In an alternative embodiment, not expressly shown in the figures, at least some of the air flow into the inlet valving 111 comes from another source then the compressor stage 101. For example, it is contemplated that in embodiments where the engine 100 has a bypass flow, at least some of the bypass flow is also directed into the valving 111. The amount of this additional flow is to be determined based on desired operational and performance characteristics.

In a further alternative embodiment an additional plenum volume (not shown) is positioned within the casing 107 adjacent the inlet valving 111. In such an embodiment, the additional plenum volume aids in slowing down the air flow and allowing for easier transition of the flow into the valving 111.

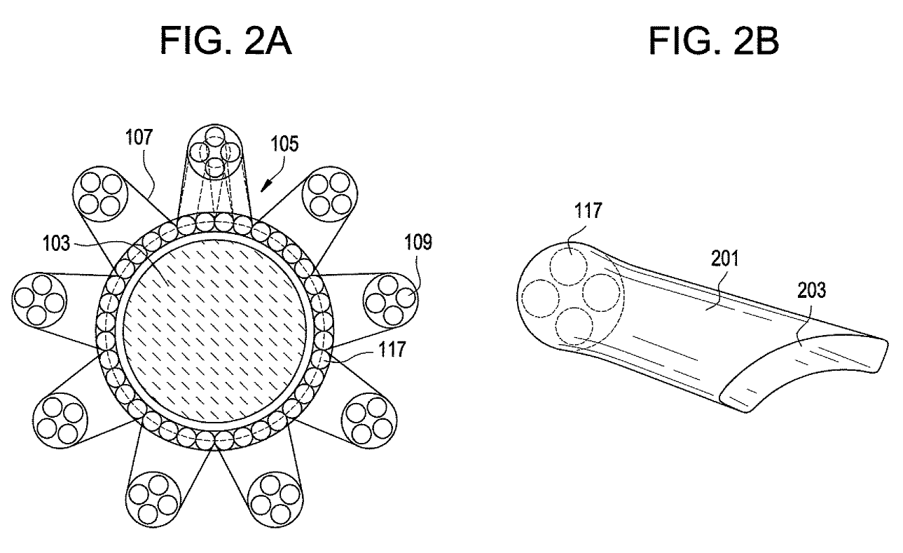

In an exemplary embodiment of the present invention, the PDCs 109 are coupled to the turbine stage 103 (typically to a high pressure turbine stage) via nozzles 117, which can also be considered PDC transition portions. The exact configuration and implementation of the nozzles 117 will vary depending on design and operational parameters. In the exemplary embodiment shown, the nozzles 117 are converging-diverging nozzles, whose structure and operation are known. In another embodiment the nozzle 117 is a converging nozzle, or a diverging nozzle. Further, the transition between the nozzles 117 and the turbine stage 103 is a function of the structural and operational parameters of the particular engine 100 in which the present invention is employed. For example, it is contemplated that in some embodiments, each individual PDC 109 will be directly coupled, via its nozzle 117, to the turbine stage 103. However, it is also contemplated that two or more PDCs 109 can be directed into a single manifold structure where their respective flows are mixed, and then the common manifold structure is directed to the turbine stage 103. This is depicted in the exemplary embodiment shown in FIGS. 2A and 2B.

Turning now to FIGS. 2A and 2B, FIG. 2A depicts a cross-section of an exemplary embodiment of a PDC stage 105 looking aft at the entrance of the turbine stage 103. In this embodiment, the PDC stage 105 contains thirty-six PDCs 109 positioned radially around the centerline of the engine 100. Of course, the present invention is not limited to this express embodiment, as various alternatives are contemplated. As shown in this embodiment, the PDCs are grouped at their forward inlet portion in groups of four, having a circular pattern, whereas the nozzles 117 are positioned adjacent to each other in a large singular circular pattern such that each nozzle 117 exits directly into the turbine stage 103. (It is noted that for clarity of the figure, the individual tubes of the PDCs 109 are shown in the uppermost grouping in the figure. In this embodiment, the nozzles 117 are positioned such that they are directly adjacent to each other in this figure only). However, the present invention is not limited in this regard as there can be spacing between adjacent nozzles 117 or groups of nozzles 117. Further, the present invention is not limited to grouping the inlet sections of the PDCs 109 as shown (groups of four). It is noted that the inlets can be positioned individually (separately from other PDC inlets) or in groups of any number deemed appropriate. However, it is noted that if the grouping gets too large the tubing of the PDCs 109 may tend to be relatively complex due to the need to route the PDC exhaust to the turbine stage 103.

In the exemplary embodiment shown in FIG. 1, each of the PDCs 109 has its own inlet valving 111. However, the present invention is not limited in this regard. Specifically, in the embodiment shown in FIG. 2A, each grouping of PDCs 109 can share an inlet valving 111 which controls air flow into each PDC 109 within the grouping. Such inlet valving systems and structures are known and will not be discussed in detail herein. In such an embodiment, the PDCs 109 can be operated simultaneously, alternately or sequentially as needed or desired.

FIG. 2B depicts an exemplary embodiment of a nozzle manifold structure 201 which can also be used. In this embodiment, a grouping of four PDCs 109, similar to what is shown in FIG. 2A, are directed to the manifold 201 which allows the exhaust from each individual PDC 109 to merge prior to entering the turbine stage 103. As shown, the nozzles 117 direct their respective exhaust in the manifold 201 such that the cumulative exhaust of the nozzles 117 exits the manifold at its exit 203 and into the turbine stage 103.

In an exemplary embodiment of the invention, it is contemplated that the four PDCs 109 coupled to a single manifold are operated 25% out-of phase with each other. In such an embodiment, because four PDCs 109 are directed to a single manifold 201 a relatively constant flow is directed into the turbine stage 103 so as to minimize the adverse affects of extreme pressure spikes (from all four PDCs 109 firing at the same time) into the turbine stage 103. It is also contemplated that in the grouping of four (or whatever number is selected) some PDCs 109 are employed and some standard combustion devices are employed. Thus, the standard combustion devices will provide constant flow, whereas the PDCs will provide the desired PDC flow. The exact operation and mixture of these components is a function of the desired operational and performance characteristics of the engine 100, and those of ordinary skill in the art are capable of choosing and implementing their desired configuration.

In exemplary embodiments of the present invention, the PDCs 109 have relatively small diameters. For example, the PDCs can have diameters in the range of about 2 to 4 inches. By using relatively small diameters, the internal stresses within an individual tube is minimized, thus reducing the overall thickness of the PDC 109 tube walls. Additionally, the overall length of the PDC 109 is reduced allowing for a compact PDC stage 105. This is because as the diameter of the PDC 109 increases, the overall length of the PDC needs to increase to allow for proper detonation operation.

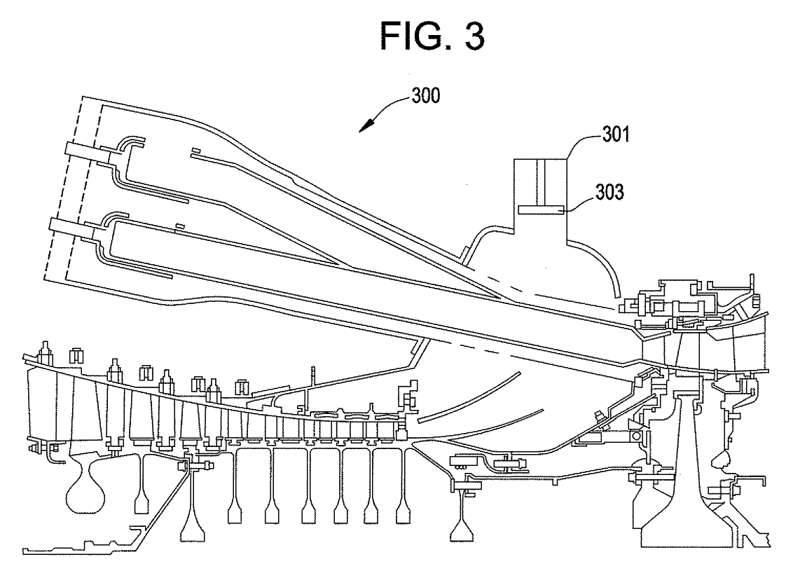

Turning now to FIG. 3, an additional exemplary engine 300 of the present invention is depicted. (It is noted that because the bulk of the Figure is identical to FIG. 1, like reference numbers have been deleted.) In this embodiment, the plenum 115 has a resonant cavity 301 coupled to it. The resonant cavity 301 provides additional damping for the pressure oscillations that can be experienced because of pressure waves leaking back through the valving 111 and the opening and closing of the valves themselves. In an exemplary embodiment, the resonant cavity 301 contains a dampening structure 303 which oscillates as pressure within the resonant cavity 301 and plenum 115 increases and decreases. Thus the dampening structure 303 effectively increases and decreases the volume of the plenum 115 to effectively absorb the pressure oscillations experienced. Thus, the compressor flow from the outlet 121 sees reduced pressure oscillations, which assists the compressor stage 101 to operate normally and optimally.

The dampening structure 303 can be any mechanical type system (such as an oscillating damped position), or can be any other type of dampening mechanism (such as a viscous liquid), or an acoustic type damper (quarter-wave damper).

In a quarter-wave damper the length of the cavity is chosen to be a quarter of the wavelength of the oscillation that is to be dampened. As waves enter the tube and reflect back, their phase is effectively shifted and they destructively interfere with the remaining waves in the plenum 115. This reduces the amplitude of the oscillations within the plenum 115 at that given frequency. In an exemplary embodiment of the present invention, a plurality of quarter-wave tubes are employed having different sizes so that different frequencies of oscillation within the plenum 115 can be reduced or removed. In a further exemplary embodiment the quarter-wave tubes have an adjustable piston structure (such as item 303) which allows the length of the tubes to be adjusted. In such an embodiment, the adjustment of the pistons, and thus the tube length, can be adjusted actively (i.e., during operation) to tune the dampening to the oscillations being experienced during engine operation.

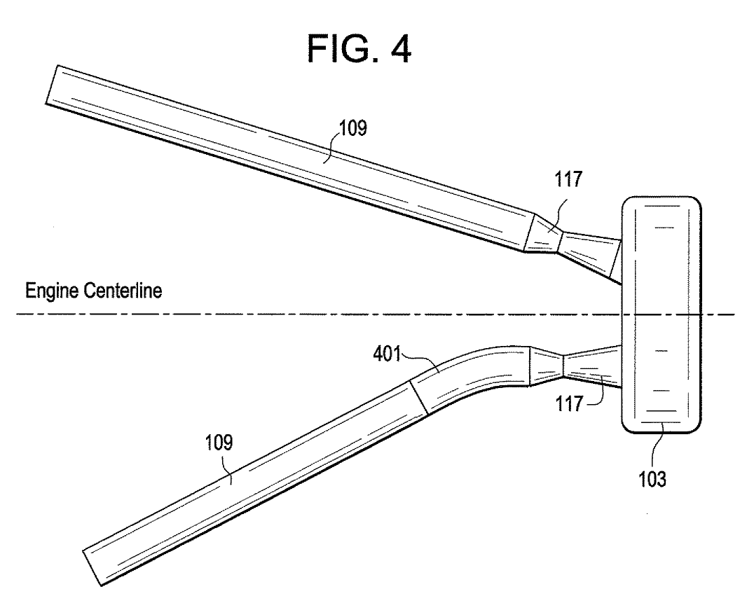

FIG. 4 depicts alternative configurations regarding the orientation of the PDCs 109 with respect to the orientation of the PDC exhaust into the turbine stage 103 (simply depicted). As shown in the upper portion of this figure (which is also consistent with FIGS. 1 and 3) the exhaust gas of the PDC 109 is directed into the turbine stage 103 at an angle with respect to the centerline of the engine. Of course, it is noted that even though the nozzle 117 is shown directly coupled to the turbine stage 103, this is not intended to be limiting. This depiction is merely intended to be representative of the angular orientation. Of course a manifold structure 201, like that shown in FIG. 2B, may be used as well as any other appropriate means to direct the flow into the turbine stage 103.

In the bottom portion of this figure, alternative embodiment is shown. In this embodiment, although the PDC 109 is angled with respect to the centerline of the engine, the exhaust of the PDC 109 is directed parallel to the centerline as it enters the turbine stage 103. In this embodiment, a direction manifold structure 401 is employed to change the direction of the flow so as to be effectively parallel with the centerline. In this embodiment, the angle of the PDC 109, with respect to the centerline of the engine 100 should be as small as possible, to reduce the heat load on the direction manifold structure 401.

It will be appreciated that the orientation and configuration employed is a function of the design and operational parameters of the engine and turbine stages employed. Those of ordinary skill in the art are capable of determining and implementing the optimal configuration, taking into account the necessary parameters and design criteria.

It is also noted that the above discussions regarding “flow” and “flow direction” are intended to be general in nature. It is certainly understood and appreciated that the many flows involved in systems incorporating the present invention can be turbulent and have infinite internal flow directions. In recognizing this, when flow is described as “parallel,” for example, that is understood to mean a general flow direction.

It is noted that although the present invention has been discussed above specifically with respect to aircraft and power generation applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. An engine, comprising:
a compressor stage having an outlet through which a compressed flow passes;
a pulse detonation combustor stage comprising at least one pulse detonation combustor, wherein said pulse detonation combustor stage is coupled to said compressor stage; and
a turbine stage coupled to said pulse detonation combustor stage which receives an exhaust from said pulse detonation combustor stage,
wherein said at least one pulse detonation combustor comprises an inlet portion which is positioned such that at least some of the compressed flow from said compressor stage travels to said inlet portion in a direction substantially opposite that of a flow of said pulse detonation combustor.

2. The engine of claim 1, wherein at least a portion of said at least one pulse detonation combustor is angled with respect to a centerline of said engine.

3. The engine of claim 1, wherein said at least one pulse detonation combustor is positioned radially away with respect to a centerline of said engine.

4. The engine of claim 1, wherein said inlet portion is positioned radially with respect to a centerline of said engine and forward of said compressor outlet.

5. The engine of claim 1, wherein said inlet portion is positioned within a casing and said at least some of said flow from said compressor stage is directed into said casing.

6. The engine of claim 1, wherein said flow from said plenum travels to said inlet portion in a direction substantially 180 degrees from that of a flow of said pulse detonation combustor.

7. The engine of claim 1, wherein said at least one pulse detonation combustor comprises an exit nozzle which is directly coupled to said turbine stage.

8. The engine of claim 1, wherein said compressor stage further comprises a diffuser which directs at least a portion of the compressed flow into a plenum.

9. The engine of claim 7, wherein a resonant cavity is coupled to said plenum structure, and said resonant cavity comprises either an active or passive pressure dampening device.

10. The engine of claim 1, wherein said at least some of said compressed flow passes through a shroud structure prior to reaching said inlet portion.

11. An engine, comprising:
a compressor stage having an outlet through which a compressed flow passes and a diffuser which directs at least a portion of the compressed flow into a plenum;
a pulse detonation combustor stage comprising a plurality of pulse detonation combustors, wherein said pulse detonation combustor stage is coupled to said plenum; and
a turbine stage coupled to said pulse detonation combustor stage which receives an exhaust from said pulse detonation combustor stage,
wherein said plurality of pulse detonation combustors comprises at least one inlet portion which is positioned such that at least some of the compressed flow from said plenum travels to said at least one inlet portion in a direction substantially opposite that of a flow of said pulse detonation combustor.

12. The engine of claim 1, wherein at least a portion of at least some of said plurality of pulse detonation combustors is angled with respect to a centerline of said engine.

13. The engine of claim 11, wherein said at least one inlet portion is positioned radially away with respect to a centerline of said engine and forward of said compressor outlet.

14. The engine of claim 11, wherein said at least one inlet portion is positioned within a casing and said at least some of said flow from said plenum is directed into said casing.

15. The engine of claim 11, wherein said flow from said plenum travels to said inlet portion in a direction substantially 180 degrees from that of a flow of said pulse detonation combustor.

16. The engine of claim 14, wherein said plurality of said pulse detonation combustors are positioned within said casing and share said at least one inlet portion.

17. The engine of claim 11, wherein a resonant cavity is coupled to said plenum structure, and said resonant cavity comprises either an active or passive pressure dampening device.

18. The engine of claim 11, wherein said at least some of said compressed flow passes through a shroud structure prior to reaching said inlet portion.

19. The engine of claim 11, wherein said plurality of pulse detonation combustors are coupled to a manifold structure and said manifold structure is directly coupled to said turbine stage.

20. An engine, comprising:
a compressor stage having an outlet through which a compressed flow passes and a diffuser which directs at least a portion of the compressed flow into a plenum;
a pulse detonation combustor stage comprising at least one pulse detonation combustor, wherein said pulse detonation combustor stage is coupled to said plenum; and
a turbine stage coupled to said pulse detonation combustor stage which receives an exhaust from said pulse detonation combustor stage,
wherein said at least one pulse detonation combustor comprises an inlet portion which is positioned such that at least some of the compressed flow from said plenum travels to said inlet portion in a direction substantially 180 degrees that of a flow of said pulse detonation combustor, and
wherein at least a portion of said at least one pulse detonation combustor is angled with respect to a centerline of said engine.
